(19) United States
(12) Patent Application Publication
(10) Pub. No.: US 2002/0179694 A1
(43) Pub. Date: Dec. 5, 2002

(54) Method and metals to produce an electrode anode to electrolyze liquid wastes

(76) Inventor: Markos Ninolakis, Athens (GR)

Correspondence Address: CARELLA, BYRNE, BAIN, GILFILLAN, CECCHI,, STEWART & OLSTEIN, 6 BECKER FARM ROAD, ROSELAND, NJ, 07068, US

(21) Appl. No.: 10/088,438

(22) PCT Filed: Jul. 11, 2001
(86) PCT No.: PCT/GB01/00031

(30) Foreign Application Priority Data
Jul. 13, 2000 (GR) 000100233

(51) Int. Cl. B23H 1/00

(52) U.S. Cl. 228/234.1; 219/69.11

(57) ABSTRACT

The methods comprises the bonding of defined metals between them by assistance of mechanical pressure and direct electric current so that the local temperature allow the bonding of different metals or alloys without any of them to lose their specific characteristics and to react like one piece of metal with extremely resistance to the electrochemical oxidation. Due to the generating of high oxidants as H₂, Cl₂, ClO₃, O₃, O₂, H₂O₂, [OH], [CLOH], [O], through electrolysis, this anode is effective enough to eliminate liquid wastes.

My invention refers to the method of bonding different alloys of metals to produce an anode capable to electrolyze liquid wastes.

Specifically in a main body of titanium or alloy of titanium/palladium, or titanium that enclose a copper bar or a bar of aluminum, or an alloy of titanium/palladium that enclose a copper bar or a bar of aluminum. Presence of mechanical pressure and suitable temperature produced from an electric welding device and noble inert gas or in a vacuum surround the coat and weld of two layers in the main substrate is achieved. The first layer is from tantalum or niobium or hafnium or zirconium or alloys of them and the second one from platinum or rhodium or iridium or ruthenium or palladium or zirconium or alloys of theme.

The said anode has very durable operating capacity and produce strong oxidants.

### LEVEL OF CONVENTIONAL TECHNOLOGY

The known today electrodes use titanium or niobium anode where the main substrate is coated by electroplating method or by layers with metal oxides of the VIII group of the periodic elements table. The efficient life of these anodes is short and cannot support intense flow of electric current for a long period of time. The main substrate is affected from electrochemical corrosion, especially by the production of nascent chlorine in the upper layers.

### ADVANTAGE OF THE INVENTION

The anode I invented can due to the bonding method and the alloys used support strong flows of electric power, 380V and 1000Amp without any disintegration of the main substrate. And at the same time due to the average of high voltage, more than 15volts, a production of strong oxidants as H₂, Cl₂, ClO₃, O₃, O₂, H₂O₂, [OH], [CLOH], [O] will take place which are the perfect elements to eliminate the liquid wastes.

### PRESENTATION OF THE INVENTION

A main substrate of titanium or an alloy of titanium-palladium or titanium that enclose a copper bar or an aluminum bar or an alloy of titanium-palladium that enclose a copper bar or aluminum one which by mechanical treatment gets a coarse surface. After it is cleaned chemically from any oxidants that may stick to the surface, it is put in a specially made device composed from a stable bench and a moving precision unit which contain a welding device with a moving mechanism including the control instruments for temperature and electric density flow as well the injection unit for the noble inert gas.

The main substrate aligned on the stable bench can rotate with a mechanical device on his axe according to the desired rotation. The foil layers advance towards the substrate so that there is a firm contact. The tantalum or niobium or zirconium or hafnium foil or alloys of them in a thickness of 0.5 mm or down to 0.015 mm lays in contact with the substrate, followed by a second foil in the same range of thickness of platinum or rhodium or iridium or ruthenium or palladium or zirconium or alloys of theme. The assemblage substrate and foils layers comes in contact with the moving welding device, where the edge is made by a rotating tungsten rod of small diameter.

The welding edge trough the tungsten rod provide a mechanical vertical pressure to the above layers and substrate from 1 to 9 kg/cm² and a discharge of electric power of 0.05 up to 6 volts and a amperage suitable to provide a current in the range of 1 to 15 kva/cm²with a parallel supply of inert noble gas to avoid oxidation cavities.

The temperature achieved must be between 100 and 500° C. bellow the melting point of the substrate, which is sufficient to soften the metals. The mechanical pressure applied achieves with the adhesion of the metal foils to the substrate without any loss of their specific characteristics. The welding edge during the said operation moves in the direction of the substrate axis and always perpendicular with a speed of 15 cm/min. The produced heat is dissipated with the move of the welding unit.

### EXAMPLE

A titanium bar 2.5 cm of diameter and 15 cm long is roughened by sand blasting and chemically cleaned from any oxidants and organic residues with oxalic acid.

The prepared bar is placed on the specially made device and in direct contact with two independent foils where the fist one is niobium 0.025 mm thick and the second is platinum 0.025 mm thick.

On the above assemble of titanium, niobium, platinum, through the welding unit I apply a pressure of 5 kg/cm² and an electric discharge of direct current 1.5 volts and an suitable amperage to provide 8 kva/cm² and at the same time supply through the nozzle with argon gas.

The developed temperature is 100 to 500° C. below the melting point of the titanium that is 1675° C. By moving the welding edge of the device always vertical to the axis of the assemble titanium, niobium, platinum with a speed of 15 cm/min a successful softening of the titanium is achieved and a total engagement of the applied foil layers niobium and platinum to the titanium is reached.

The welding device rotates the titanium bar so it will have a uniform cover of niobium and platinum.

1. The method of producing anode for liquids electrolysis that is made by bonding two thin foils. The first one from tantalum or niobium or zirconium or hafnium foil or alloys of them, and a second one of platinum or rhodium or iridium or ruthenium or palladium or zirconium or alloys of theme. On a main substrate of high resistance to electrolytic oxidation by applying a vertical mechanical pressure and topic temperature through a special electric welding device in presence of noble gas or in vacuum.

2. The method as described in claim 1, where the main substrate is a bar or a plate of titanium.

3. The method as described in claim 1, where the main substrate is a bar or a plate of titanium-palladium alloy.

4. The method as described in claim 1, where the main substrate is a bar or a plate of titanium that covers copper.

5. The method as described in claim 1, where the main substrate is a bar or a plate of titanium that covers aluminum

6. The method as described in claim 1, where the main substrate is a bar or a plate of titanium-palladium alloy that covers copper

7. The method as described in claim 1, where the main substrate is a bar or a plate of titanium-palladium alloy that covers aluminum

8. The method as described in claim 1, where the first layer to the substrate is tantalum or niobium or zirconium or hafnium foil or alloys of them 0.5 mm to 0.015 mm thick.

9. The method as described in claim 1, where the second layer to the substrate is platinum or rhodium or iridium or ruthenium or palladium or zirconium or alloys of them 0.5 mm to 0.015 mm thick.

10. The method as described in claim 1, where the vertical pressure applied to the assemblage of the substrate and the layers is from 1 to 9 kg/cm²

11. The method as described in claim 1, where the direct electric voltage applied is 0.05V to 6V and the amperage suitable to provide 1.5 to 15 Kva/cm²

12. The method as described in claim 1, where the temperature developed by the application of the direct electric current is 100 to 500° C. bellow the melting point of the substrate.

13. The method as described in claim 1, where the noble gas is Argon.
